(19) United States
(12) Patent Application Publication
(10) Pub. No.: US 2007/0217759 A1
(43) Pub. Date: Sep. 20, 2007

(54) Reverse Playback of Video Data

(75) Inventor: Michael D. Dodd, Kirkland, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/276,711

(22) Filed: Mar. 10, 2006

(51) Int. Cl. H04N 5/91

(52) U.S. Cl. 386/68

(57) ABSTRACT

A first group of video frames are decompressed to create a first group of decompressed video frames. The first group of decompressed video frames are compressed in reverse order to create a first group of reverse-order video frames. A second group of video frames are decompressed to create a second group of decompressed video frames, such that the second group of decompressed video frames are to be displayed prior to the first group of video frames. The second group of decompressed video frames are compressed in reverse order to create a second group of reverse-order video frames. The first and second groups of reverse-order compressed video frames are joined together. A determination is made regarding whether playback of the joined video frames will cause a buffer violation. If a buffer violation would occur, a last compressed frame is discarded from the first group of reverse-order compressed video frames.

### BACKGROUND

Video streams, such as VOD (Video On Demand) and other streamed video programs, are typically played at a standard rate. However, at certain times, users may want to fast-forward or rewind the video stream. One way of simulating fast-forward and rewind functions is to generate one or more “trick streams”. For example, for a two hour VOD stream, a 15× fast-forward stream will be an eight minute long clip that, when played at normal rate, will appear to the user as though the original stream were being played at fast-forward. This trick stream can be generated by decompressing the original video stream, removing 14 out of every 15 frames, and re-compressing the resulting stream.

Although the above solution works well for forward streams, a different approach is needed for reverse (e.g., rewind) streams. To display a reverse stream that has been compressed using a modem video compression technique, the system cannot simply decompress the original stream backwards. Many video compression techniques, such as MPEG-2 (Moving Pictures Experts Group), generate multiple difference frames that depend on previous frames to be decoded properly. For example, MPEG-2 includes “I-frames”, which contain compressed data that reflects the entire video image without relying on any previous or subsequent frames. MPEG-2 also includes difference frames (e.g., “P-frames” and “B-frames”), which do not encode the entire image. Instead, the difference frames contain the differences between the current frame and the previous reference frame. Thus, the difference frames typically contain significantly less data than the I-frames, thereby reducing the amount of data transmitted for a particular video program. Since the difference frames rely on previous reference frames, merely decompressing an original stream backwards does not work to create a reverse stream.

Therefore, it would be desirable to provide a system that is capable of creating a reverse playback stream that works with existing video compression systems.

### SUMMARY

The systems and methods described herein decompress multiple groups of video frames and compress each group of video frames in reverse order. The multiple groups are then joined together for playback. If playback of the joined groups would cause a buffer violation, then one or more frames are discarded from a first group of video frames or a size associated with a bitrate window is adjusted to avoid a buffer violation.

### BRIEF DESCRIPTION OF THE DRAWINGS

Similar reference numbers are used throughout the figures to reference like components and/or features.

FIG. 1 illustrates an example system that provides a “normal” playback of video data as well as several different “trick” streams.

FIG. 2 is a flow diagram illustrating an embodiment of a procedure for processing multiple groups of video frames for playback in reverse order.

FIG. 3 illustrates an example generation of a stream of video frames for playback in reverse order.

FIG. 4 is a flow diagram illustrating a first embodiment of a procedure for avoiding a buffer violation when playing the stream of video frames in reverse order.

FIG. 5 is a flow diagram illustrating a second embodiment of a procedure for avoiding a buffer violation when playing the stream of video frames in reverse order.

FIG. 6 illustrates various components of an example client device in which the systems and methods discussed herein can be implemented.

FIG. 7 illustrates various devices and components in an example entertainment and information system in which the systems and methods discussed herein can be implemented.

### DETAILED DESCRIPTION

The systems and methods described herein process multiple groups of video frames and compress each group of video frames in reverse order. The multiple groups are then joined together in a manner that avoids buffer violations. For example, the described systems and methods decompress a group of video frames from the beginning of a video program and compress that group of video frames in reverse order. The systems and methods then decompress a second group of video frames, compress the second group of video frames in reverse order, and then join the two groups of compressed video frames together. This technique may continue to join any number of groups of video frames.

The described systems and methods take into consideration the codec (compressor/decompressor) buffer model to be sure the buffer model is not violated (e.g., avoid a buffer overflow or a buffer underflow). The systems and methods described herein function with any codec and do not require any changes to the operation of the codec.

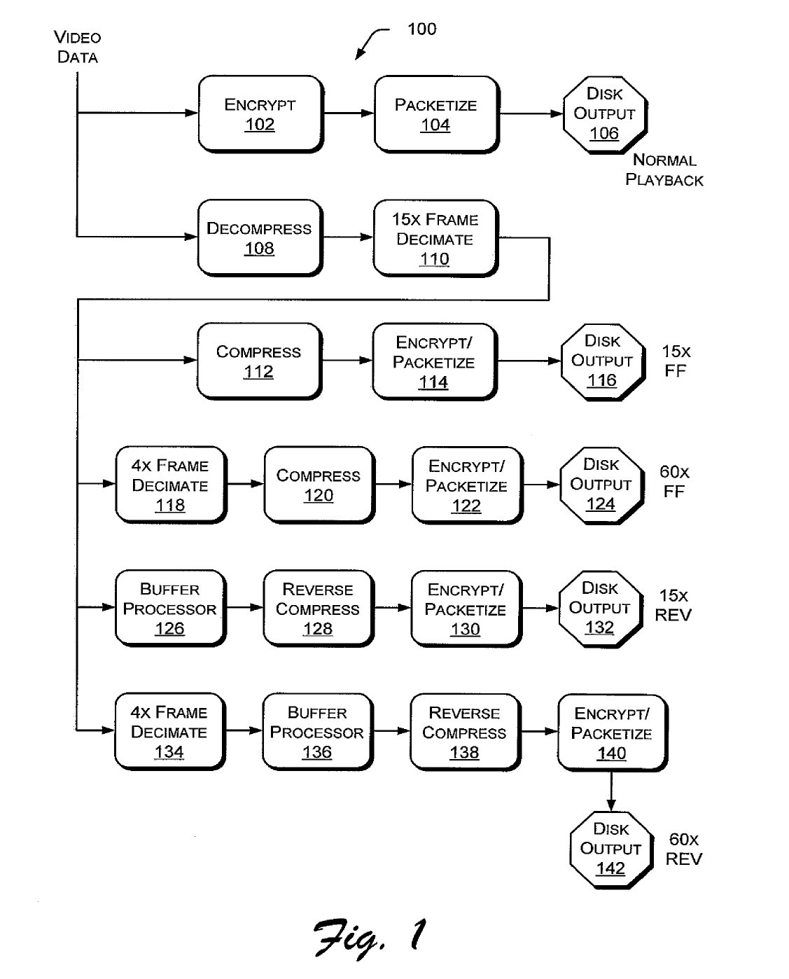

FIG. 1 illustrates an example system 100 that provides a “normal” playback of video data as well as several different “trick” streams, such as fast-forward and rewind. Video data is received by an encryption module 102 and a decompression module 108. Video data may be received from any source and may include streamed data, data retrieved from a storage device, or data received from any other source. Encryption module 102 is capable of encrypting and decrypting video data. Encryption module 102 provides video data to an optional packetization module 104, which is capable of packetizing the video data into multiple packets and communicating those packets to a disk output 106. The video data provided to disk output 106 represents a “normal playback” mode for the video data (i.e., real-time playback of the data).

Decompression module 108 receives the video data, decompresses the received video data, and provides the decompressed video data to a 15× frame decimator 110. Frame decimator 110 discards 14 out of every 15 frames of video data. The output of frame decimator 110 is provided to a compression module 112, a 4× frame decimator 118, a buffer processor 126, and another 4× frame decimator 134.

Compression module 112 receives frames of video data from frame decimator 110 and compresses the received frames of video data. The compressed video data is provided to an encryption/packetization module 114, which encrypts the video data and packetizes the video data into multiple packets that are communicated to a disk output 116. The data provided to disk output 116 represents a 15× Fast-Forward trick stream. The data is 15× normal playback speed because 14 out of every 15 frames of video data was discarded by 15× frame decimator 110.

4× frame decimator 118 receives video data from 5× frame decimator 110. 4× frame decimator 118 discards three out of every four frames of received video data. Thus, the output from 4× frame decimator 118 is 60× the normal playback speed (15*4=60). The output of 4× frame decimator 118 is provided to a compression module 120, which compresses the received video data. The compressed video data is provided to an encryption/packetization module 122, which encrypts the video data and packetizes the video data into multiple packets that are communicated to a disk output 124. The data provided to disk output 124 represents a 60× Fast-Forward trick stream.

Buffer processor 126 receives video data from 15× frame decimator 110. Buffer processor 126 buffers groups of video frames and provides the frames for each group in reverse order to a reverse compression module 128. Reverse compression module 128 compresses the video frames and drops frames, if necessary, to preserve the codec's buffer model. Additional details regarding the operation of buffer processor 126 and reverse compression module 128 are provided below. The output of reverse compression module 128 is provided to an encryption/packetization module 130, which encrypts the received video data and packetizes the video data into multiple packets that are communicated to a disk output 132. The data provided to disk output 132 represents a 15× rewind (or reverse) trick stream.

4× frame decimator 134 receives video data from 15× frame decimator 110. 4× frame decimator 134 discards three out of every four frames of received video data. Thus, the output from 4× frame decimator 134 is 60× the normal playback speed (15*4=60). The output of 4× frame decimator 134 is provided to a buffer processor 136, which buffers groups of video frames and provides the frames for each group in reverse order to a reverse compression module 138. Reverse compression module 138 compresses the video frames and drops frames, if necessary, to preserve the codec's buffer model. Additional details regarding the operation of buffer processor 136 and reverse compression module 138 are provided below. The output of reverse compression module 138 is provided to an encryption/packetization module 140, which encrypts the received video data and packetizes the video data into multiple packets that are communicated to a disk output 142. The data provided to disk output 142 represents a 60× rewind (or reverse) trick stream.

The example system of FIG. 1 simultaneously generates four different trick streams: 15× FF, 60× FF, 15× REV, and 60× REV. Alternate embodiments may generate any number of different trick streams, including any number of FF trick streams and any number of REV trick streams. Further, any speed value (e.g., 15× and 60×) can be used for any of the trick streams. Alternate embodiments may include other types of trick streams not shown in FIG. 1.

The packetization function performed by encryption/packetization modules 114, 122, 130, and 140 is optional for certain types of data. For example, the video data may be stored as frame-based files, which don't need to be packetized. Similarly, packetization module 104 is optional for certain types of data.

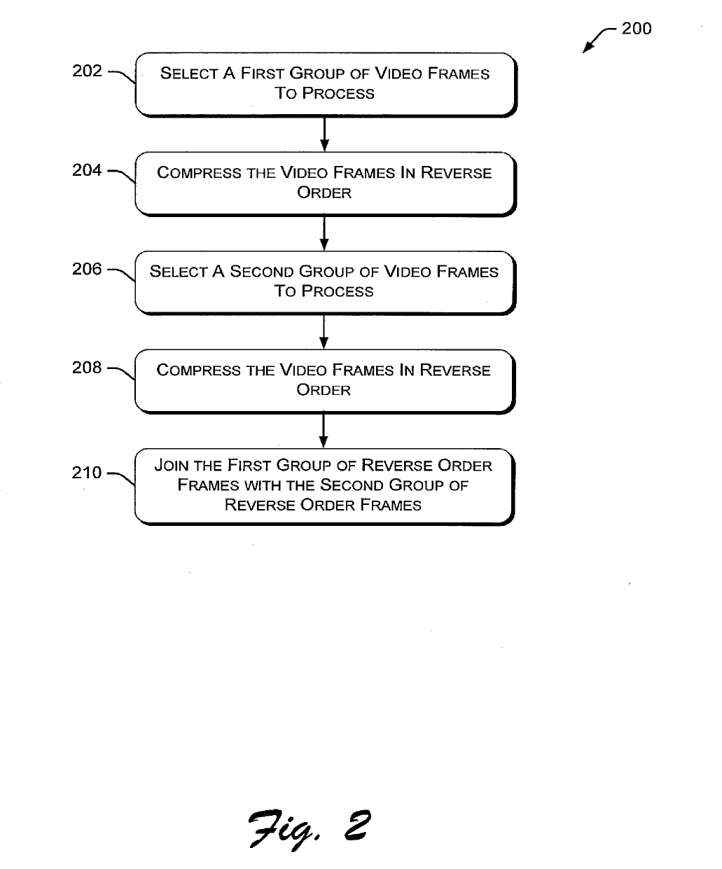

FIG. 2 is a flow diagram illustrating an embodiment of a procedure 200 for processing multiple groups of video frames for playback in reverse order. Procedure 200 may be implemented, for example, by buffer processors 126 and 136, and by reverse compression modules 128 and 138 to generate reverse trick streams at disk output 132 and 142. Initially, procedure 200 selects a first group of decompressed video frames to process (block 202). For example, the first group of video frames may include ten frames of decompressed video data. Procedure 200 continues by compressing the decompressed video frames in reverse order (block 204); i.e., in reverse chronological order.

Next, the procedure selects a second group of video frames to process (block 206). In a particular embodiment, the second group of video frames is the group of frames that occurs immediately prior to the first group of video frames (i.e., the group of frames chronologically prior to the first group of frames). In another embodiment, the second group of video frames is the group of frames that occurs immediately subsequent to the first group of video frames. As mentioned above, an example second group of video frames may include a particular number of frames of decompressed video data. The procedure continues by compressing the decompressed video frames in reverse order (block 208); i.e., in reverse chronological order. Finally, the first group of reverse order frames are joined with the second group of reverse order frames (block 210). The first group and the second group are joined in reverse chronological order. The procedure of FIG. 2 may be repeated for additional groups of video frames, which are joined with the first and second groups of reverse order frames.

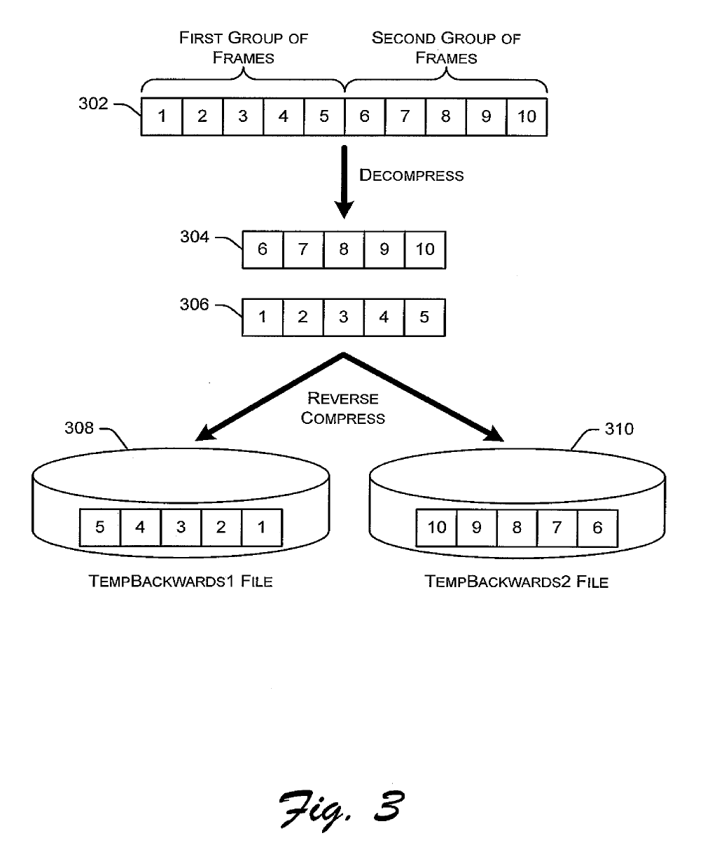

FIG. 3 illustrates an example generation of a stream of video frames for playback in reverse order The example of FIG. 3 follows procedure 200 discussed above with respect to FIG. 2. A series of ten video frames 302 are separated into a first group of frames (frames 1-5) and a second group of frames (frames 6-10). In a particular example, frames 1 and 6 are I-frames and frames 2-5 and 7-10 are difference frames. A buffer processor decompresses the video frames 302 to create decompressed frames 304 and decompressed frames 306. A reverse compression module then compresses the decompressed frames 306 in reverse order to generate a temporary file 308. The reverse compression module also compresses the decompressed frames 304 in reverse order to generate a temporary file 310. In an alternate embodiment, the reverse compression module may combine temporary file 308 and temporary file 310 into a single file on a single storage device. Temporary files 308 and 310 may be stored on any type of storage 2 device including, for example, a volatile memory device, a non-volatile memory device, or a long-term storage device such as a disk drive.

Before the two temporary files containing reverse order frames can be played (thereby creating a rewind or reverse stream), the system determines whether such reverse playback would cause any type of buffer violation. If a buffer violation will occur, the system takes preliminary action to avoid any buffer violation.

Determining where a buffer violation will occur depends on various factors, including the type of buffer model being used by the system. An example buffer model is referred to as the “leaky bucket” buffer model. The leaky bucket buffer is used by a codec when decoding compressed content. Video data flows into the buffer (e.g., into the top of the “bucket”). The buffer model is referred to as a “leaky bucket” because the decoder removes samples from the buffer regularly as if the samples were “leaking” out of the bucket. The size of the buffer used by the encoder is determined by the bitrate and buffer window size associated with the video data stream. The leaky bucket buffer model is violated if an underflow or an overflow occurs. An underflow occurs when the bucket is empty and the system needs a frame of data to display. An overflow occurs when the buffer is full (or nearly full), and additional video data is added to the buffer which causes the buffer to exceed its maximum data capacity. Although the leaky bucket buffer model is discussed by way of example, the systems and methods discussed herein may be applied to any type of buffer model.

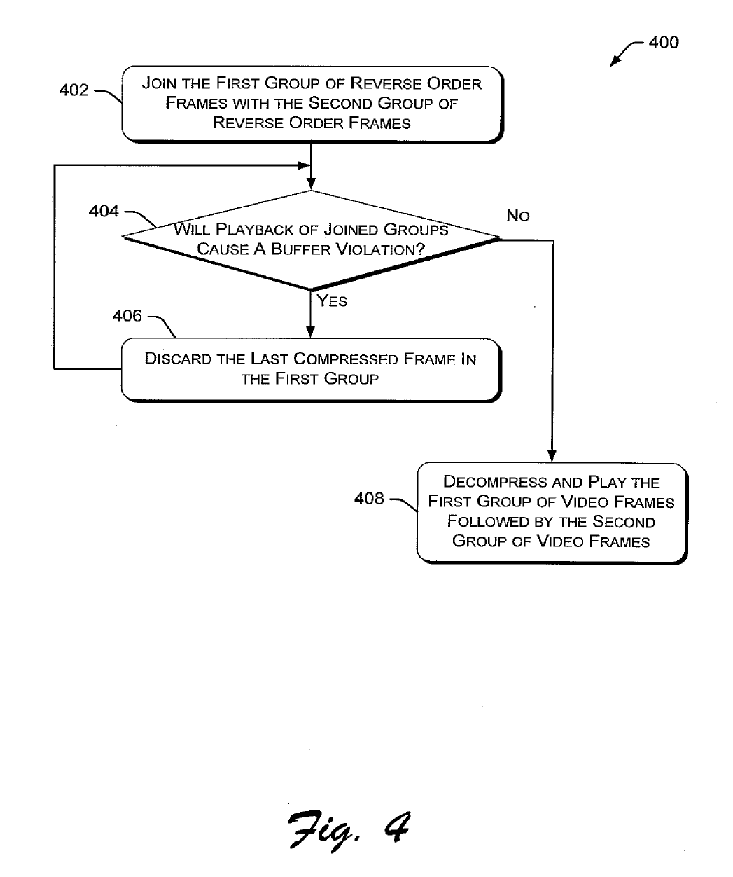

FIG. 4 is a flow diagram illustrating a first embodiment of a procedure 400 for avoiding a buffer violation when playing the stream of video frames in reverse order. Procedure 400 begins at the last step of procedure 200, where the first group of reverse order frames is joined with the second group of reverse order frames (block 402). The procedure continues by determining whether reverse playback of the joined groups will cause a buffer violation (block 404). If such playback will cause a buffer violation, then procedure 400 discards the last compressed frame in the first group of reverse order frames (block 406). In the example of FIG. 3, the procedure would discard frame 6 (the last frame as shown in temporary file 308). Discarding this frame will prevent a buffer violation, such as a buffer overflow. After discarding the frame, the procedure returns to block 404 to determine if discarding the frame has allowed playback of the joined groups without a buffer violation. If playback of the joined groups still causes a buffer violation, the procedure returns to block 406 to discard another frame. In the example of FIG. 3, the procedure would discard frame 5. After enough frames are discarded to avoid a buffer violation, the procedure branches from block 404 to block 408, which decompresses and plays the first group of video frames followed by the second group of video frames.

In the example of FIG. 4 discussed above, the procedure may be required to discard any number of compressed frames in the first group of reverse order frames to avoid a buffer violation. In some situations, the procedure may need to discard three or four compressed frames in the first group of reverse order frames to avoid a buffer violation. In other situations, the procedure may not need to discard any compressed frames in the first group of reverse order frames to avoid a buffer violation. The number of frames that must be discarded depends on the size of the frames being discarded and the available space in the buffer to receive the non-discarded frames.

In an example of discarding a frame, a reverse compression module receives a batch of frames in order: 5, 4, 3, 2, 1 from a buffer processor. For this example, assume a bitrate of one megabit per second compression, compressing with a one second buffer window, and two frames per second. The buffer allocation is defined by the bitrate and the buffer window (i.e., buffer allocation is one megabit). To model the leaky bucket buffer, the concept of transmission time is utilized. As long as the last byte of the frame has finished transmitting prior to its “Decode Time”, then the buffer model has not been violated. In this example, the first group of frames could be compressed as shown in Table 1 below.

TABLE 1

| | Decode | | Start Transmit | End Transmit |
|---|---|---|---|---|
| Frame # | Time | Frame Size | Time | Time |
| 5 | 150.0 | 1.00 Mbit | 149.0 | 150.0 |
| 4 | 150.5 | 0.50 Mbit | 150.0 | 150.5 |
| 3 | 151.0 | 0.20 Mbit | 150.5 | 150.7 |
| 2 | 151.5 | 0.30 Mbit | 150.7 | 151.0 |
| 1 | 152.0 | 0.90 Mbit | 151.0 | 151.9 |

Then, the next group (e.g., the second group) of frames arrives. Although this second group of frames arrives after the first group of frames, the second group of frames will be prior to the first group when played, so their decode times are earlier. Table 2 below illustrates the parameters associated with the second group of frames.

TABLE 2

| | Decode | | Start Transmit | End Transmit |
|---|---|---|---|---|
| Frame # | Time | Frame Size | Time | Time |
| 10 | 147.5 | 0.90 Mbit | 146.5 | 147.4 |
| 9 | 148.0 | 0.40 Mbit | 147.4 | 147.8 |
| 8 | 148.5 | 0.20 Mbit | 147.8 | 148.0 |
| 7 | 149.0 | 0.50 Mbit | 148.0 | 148.5 |
| 6 | 149.5 | 0.80 Mbit | 148.5 | 149.3 |

The frames are scheduled to be played back in the following order: 10, 9, 8, 7, 6. However, a problem will occur when frames 5-1 are played after frames 10-6, because the buffer model has been violated. The buffer model is violated because the start transmit time for frame 5 has to be the end transmit time for frame 6 (149.3). Since frame 5 is one megabit in size, its end transmit time will be 150.3. Thus, frame 5 doesn't finish transmitting until it is too late.

Both groups of frames assumed that the entire buffer window was empty at the beginning of the sequence. Additionally, the initial frame is generally an I-frame, which tends to be a large, thereby making the outcome more likely. As discussed herein, there are two alternate solutions to this problem. The first is to simply discard frame 6, which is probably not a problem with a trick stream that is running at a high speed (e.g., 15× or 60×). If frame 6 is dropped, the times look like the following in Table 3 below.

TABLE 3

| | Decode | | Start Transmit | End Transmit |
|---|---|---|---|---|
| Frame # | Time | Frame Size | Time | Time |
| 7 | 149.0 | 0.50 Mbit | 148.0 | 148.5 |
| 5 | 150.0 | 1.00 Mbit | 148.5 | 149.5 |

Thus, buffer has not been violated.

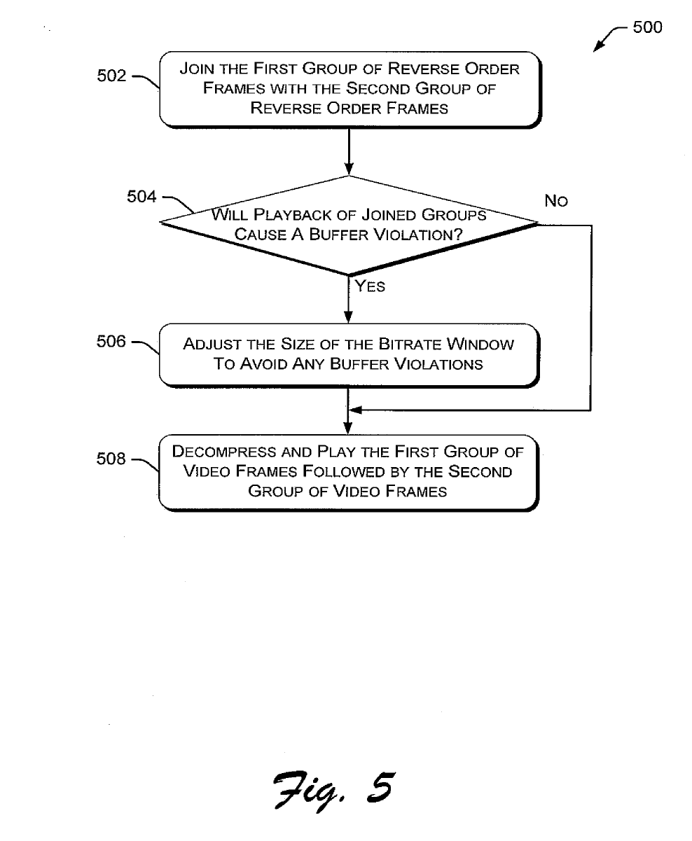

A second solution (see FIG. 5) realizes that the compression can be completed using a different buffer window than is specified for playback. Using the same bitstream compressed with a one second buffer window, the playback engine will be told that the buffer window is two seconds. Since the playback engine will buffer two seconds, this effectively adds one second to the delay between transmission time and decode time as shown in Table 4 below.

TABLE 4

| | Decode | | Start Transmit | End Transmit |
|---|---|---|---|---|
| Frame # | Time | Frame Size | Time | Time |
| 10 | 147.5 | 0.90 Mbit | 145.5 | 146.4 |
| 9 | 148.0 | 0.40 Mbit | 146.4 | 146.8 |
| 8 | 148.5 | 0.20 Mbit | 146.8 | 147.0 |
| 7 | 149.0 | 0.50 Mbit | 147.0 | 147.5 |
| 6 | 149.5 | 0.80 Mbit | 147.5 | 148.3 |

Now, when frame 5 is played after frame 6, frame 5 has the characteristics shown in Table 5 below.

TABLE 5

| | Decode | | Start Transmit | End Transmit |
|---|---|---|---|---|
| Frame # | Time | Frame Size | Time | Time |
| 5 | 150.0 | 1.00 Mbit | 148.3 | 149.3 |

Thus, the start transmit time for frame 5 is equal to the end transmit time for frame 6, thereby providing a smooth transition between the two groups of frames.

In general, different buffer windows should be used for compression and playback to reduce the possibility of dropped frames, but the frame dropping approach can and should still be used to ensure that the buffer model is not violated regardless of the output of the codecs.

FIG. 5 is a flow diagram illustrating a second embodiment of a procedure 500 for avoiding a buffer violation when playing the stream of video frames in reverse order. Procedure 500 begins at the last step of procedure 200, where the first group of reverse order frames is joined with the second group of reverse order frames (block 502). The procedure continues by determining whether reverse playback of the joined groups will cause a buffer violation (block 504). If such playback will cause a buffer violation, then procedure 500 adjusts the size of the bitrate window to avoid any buffer violations (block 506). For example, see the above situation in which the bitrate window is adjusted from one second to two seconds. Adjusting the size of the bitrate window will prevent a buffer violation, such as one or more frames not being available at the appropriate time. The procedure continues by decompressing and playing the first group of video frames followed by the second group of video frames (block 508).

Although FIGS. 4 and 5 illustrate two different approaches to avoiding buffer violations, in alternate embodiments, both approaches may be combined together. For example, in a particular system, a frame may be discarded and the bitrate window adjusted simultaneously.

In another embodiment of the invention, the procedures discussed above with respect to FIGS. 4 and 5 can be used on video data without decompressing and/or compressing the video data. For example, a system may consider just I-frames from the source video data and joins those I-frames together in reverse order to create a rewind stream. In this example, each group is a single frame (i.e., an I-frame). Each time a particular frame is added to the sequence of frames representing the rewind stream, the system determines whether or not addition of that particular frame would violate the buffer model. If addition of the particular frame would violate the buffer model, the system may discard that particular frame and move on to the next frame.

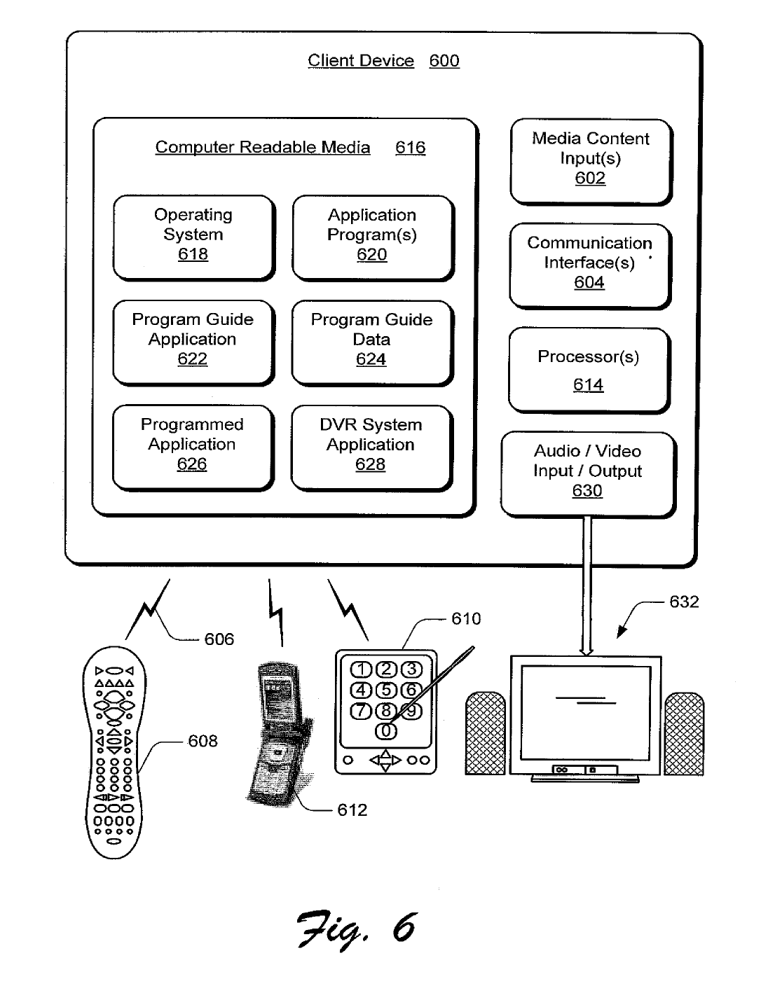

FIG. 6 illustrates various components of an exemplary client device 600 which can be implemented as any form of a computing, electronic, and/or television-based client device, and in which the systems and methods discussed herein can be implemented.

Client device 600 includes one or more media content inputs 602 which may include Internet Protocol (IP) inputs over which streams of media content are received via an IP-based network. Device 600 further includes communication interface(s) 604 which can be implemented as any one or more of a serial and/or parallel interface, a wireless interface, any type of network interface, a modem, and as any other type of communication interface. A wireless interface enables client device 600 to receive control input commands 606 and other information from an input device, such as from remote control device 608, PDA (personal digital assistant) 610, cellular phone 612, or from another infrared (IR), 802.11, Bluetooth, or similar RF input device.

A network interface provides a connection between the client device 600 and a communication network by which other electronic and computing devices can communicate data with device 600. Similarly, a serial and/or parallel interface provides for data communication directly between client device 600 and the other electronic or computing devices. A modem facilitates client device 600 communication with other electronic and computing devices via a conventional telephone line, a DSL connection, cable, and/or other type of connection.

Client device 600 also includes one or more processors 614 (e.g., any of microprocessors, controllers, and the like) which process various computer executable instructions to control the operation of device 600, to communicate with other electronic and computing devices, and to implement the embodiments described herein. Client device 600 can be implemented with computer readable media 616, such as one or more memory components, examples of which include random access memory (RAM), non-volatile memory (e.g., any one or more of a is read-only memory (ROM), flash memory, EPROM, EEPROM, etc.), and a disk storage device. A disk storage device can include any type of magnetic or optical storage device, such as a hard disk drive, a recordable and/or rewriteable compact is disc (CD), a DVD, a DVD+RW, and the like.

Computer readable media 616 provides data storage mechanisms to store various information and/or data such as software applications and any other types of information and data related to operational aspects of client device 600. For example, an operating system 618 and/or other application programs 620 can be maintained as software applications with the computer readable media 616 and executed on processor(s) 614 to implement the systems and methods discussed herein.

For example, client device 600 can be implemented to include a program guide application 622 that is implemented to process program guide data 624 and generate program guides for display which enable a user to navigate through an onscreen display and locate broadcast programs, recorded programs, video on-demand programs and movies, interactive game selections, network-based applications, and other media access information or content of interest to the user. The computer readable media 616 can also include a programmed application 626 to implement features and embodiments described herein. The computer readable media 616 can also include a DVR system application 628 to maintain and playback recorded media content.

Although the programmed application 626 is illustrated and described as a single application configured to implement embodiments described herein, the programmed application 626 can be implemented as several component applications distributed to each perform one or more functions in a client device in a television-based entertainment and information system. Further, the program guide application 622 may include the programmed application 626 as an integrated module or component.

The client device 600 also includes an audio and/or video output 630 that provides audio and video to an audio rendering and/or display system 632, or to other devices that process, display, and/or otherwise render audio, video, and display data. Video signals and audio signals can be communicated from device 600 to a television (or to other types of display devices) via an RF (radio frequency) link, S-video link, composite video link, component video link, analog audio connection, or other similar communication link.

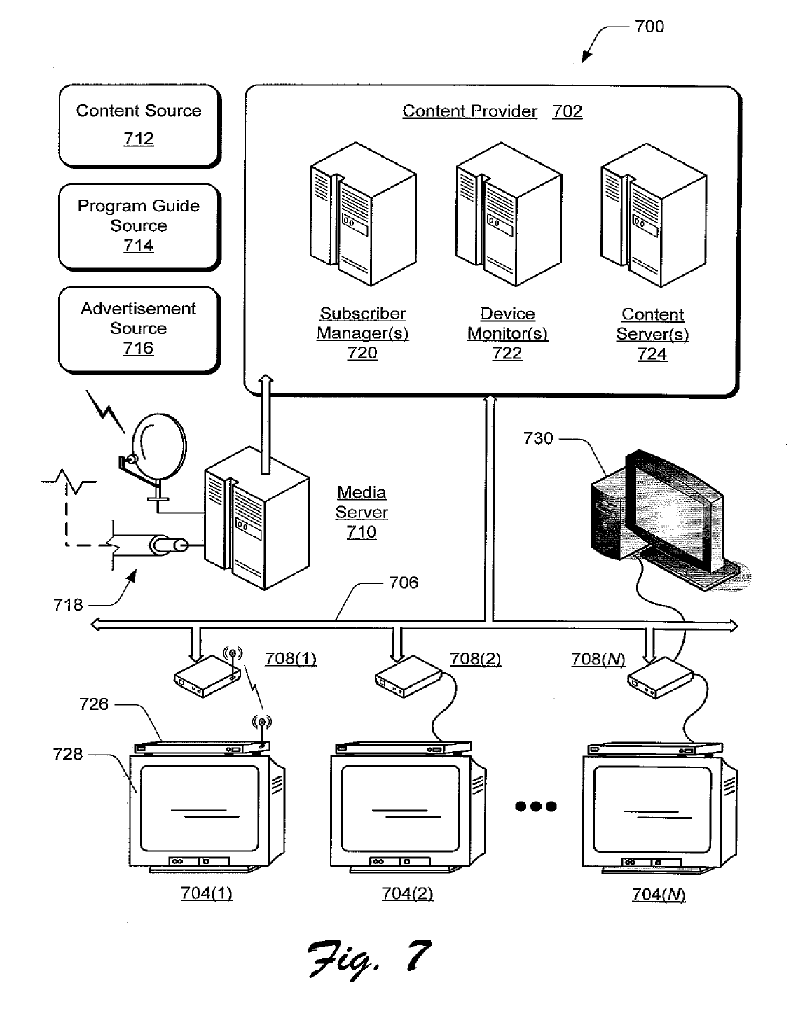

FIG. 7 illustrates an exemplary entertainment and information system 700 in which an IP-based television environment can be implemented, and in which embodiments discussed herein can be implemented. System 700 facilitates the distribution of program content, program guide data, and advertising content to multiple users. System 700 includes a content provider 702 and television-based client systems 704(1-N) each configured for communication via an IP-based network 706.

The network 706 can be implemented as a wide area network (e.g., the Internet), an intranet, a Digital Subscriber Line (DSL) network infrastructure, or as a point-to-point coupling infrastructure. Additionally, network 706 can be implemented using any type of network topology and any network communication protocol, and can be represented or otherwise implemented as a combination of two or more networks. A digital network can include various hardwired and/or wireless links 708(1-N), routers, gateways, and so on to facilitate communication between content provider 702 and the client systems 704(1-N). The television-based client systems 704(1-N) receive program content, program guide data, advertising content, closed captions data, and the like from content server(s) of the content provider 702 via the IP-based network 706.

System 700 includes a media server 710 that receives program content from a content source 712, program guide data from a program guide source 714, and advertising content from an advertisement source 716. In an embodiment, the media server 710 represents an acquisition server that receives the audio and video program content from content source 712, an EPG server that receives the program guide data from program guide source 714, and/or an advertising management server that receives the advertising content from the advertisement source 716.

The content source 712, the program guide source 714, and the advertisement source 716 control distribution of the program content, the program guide data, and the advertising content to the media server 710 and/or to other television-based servers. The program content, program guide data, and advertising content is distributed via various transmission media 718, such as satellite transmission, radio frequency transmission, cable transmission, and/or via any number of other wired or wireless transmission media. In this example, media server 710 is shown as an independent component of system 700 that communicates the program content, program guide data, and advertising content to content provider 702. In an alternate implementation, media server 710 can be implemented as a component of content provider 702.

Content provider 702 is representative of a headend service in a television-based content distribution system, for example, that provides the program content, program guide data, and advertising content to multiple subscribers (e.g., the television-based client systems 704(1-N)). The content provider 702 can be implemented as a satellite operator, a network television operator, a cable operator, and the like to control distribution of program and advertising content, such as movies, television programs, commercials, music, and other audio, video, and/or image content to the client systems 704(1-N).

Content provider 702 includes various components to facilitate media data processing and content distribution, such as a subscriber manager 720, a device monitor 722, and a content server 724. The subscriber manager 720 manages subscriber data, and the device monitor 722 monitors the client systems 704(1-N) (e.g., and the subscribers), and maintains monitored client state information.

Although the various managers, servers, and monitors of content provider 702 (to include the media server 710 in one embodiment) are illustrated and described as distributed, independent components of content provider 702, any one or more of the managers, servers, and monitors can be implemented together as a multi-functional component of content provider 702. Additionally, any one or more of the managers, servers, and monitors described with reference to system 700 can implement the features and embodiments discussed herein.

The television-based client systems 704(1-N) can be implemented to include a client device 726 and a display device 728 (e.g., a television). A client device 726 of a television-based client system 704 can be implemented in any number of embodiments, such as a set-top box, a digital video recorder (DVR) and playback system, a personal video recorder (PVR), an appliance device, a gaming system, and as any other type of client device that may be implemented in a television-based entertainment and information system. In an alternate embodiment, client system 704(N) is implemented with a computing device 730 as well as a client device 726. Additionally, any of the client devices 726 of a client system 704 can implement the features and embodiments described herein.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

1. A method comprising:
receiving a first group of decompressed video frames;
compressing the first group of decompressed video frames in reverse order to create a first group of reverse-order compressed video frames;
receiving a second group of decompressed video frames, wherein the second group of video frames are to be displayed prior to the first group of video frames;
compressing the second group of decompressed video frames in reverse order to create a second group of reverse-order compressed video frames;
joining the first group of reverse-order compressed video frames and the second group of reverse-order compressed video frames;
determining whether playback of the joined video frames will cause a buffer violation; and
discarding a last compressed frame in the first group of reverse-order compressed video frames if playback of the joined video frames will cause a buffer violation.

2. A method as recited in claim 1 further comprising decompressing and playing the first group of reverse-order compressed video frames followed by the second group of reverse-order compressed video frames.

3. A method as recited in claim 1 further comprising:
decompressing the first group of reverse-order compressed video frames;
playing the first group of reverse-order compressed video frames;
decompressing the second group of reverse-order compressed video frames; and
playing the second group of reverse-order compressed video frames.

4. A method as recited in claim 1 wherein playback of the joined video frames results in a reverse playback of the video frames.

5. A method as recited in claim 1 further comprising adjusting a size associated with a bitrate window if playback of the joined video frames will cause a buffer violation.

6. A method as recited in claim 5 wherein adjusting a size associated with a bitrate window includes doubling the size of the bitrate window.

7. A method as recited in claim 1 further comprising discarding a next-to-last compressed frame in the first group of reverse-order compressed video frames if playback of the joined video frames will cause a buffer violation

8. A method as recited in claim 1 further comprising discarding a plurality of compressed frames in the first group of reverse-order compressed video frames if playback of the joined video frames will cause a buffer violation.

9. A method comprising:
receiving a first group of decompressed video frames;
compressing the first group of decompressed video frames in reverse order to create a first group of reverse-order compressed video frames;
receiving a second group of decompressed video frames, wherein the second group of video frames are chronologically earlier than the first group of video frames;
compressing the second group of decompressed video frames in reverse order to create a second group of reverse-order compressed video frames;
joining the first group of reverse-order compressed video frames and the second group of reverse-order compressed video frames;
determining whether playback of the joined video frames will cause a buffer violation; and
adjusting a size associated with a bitrate window if playback of the joined video frames will cause a buffer violation.

10. A method as recited in claim 9 farther comprising discarding a last compressed frame in the first group of reverse-order compressed video frames if playback of the joined video frames will cause a buffer violation.

11. A method as recited in claim 9 wherein adjusting a size associated with a bitrate window includes doubling the size of the bitrate window.

12. A method as recited in claim 9 further comprising decompressing and playing the first group of reverse-order compressed video frames followed by the second group of reverse-order compressed video frames if playback of the joined video frames will not cause a buffer violation.

13. A method as recited in claim 9 further comprising decompressing and playing the first group of reverse-order compressed video frames followed by the second group of reverse-order compressed video frames after adjusting a size associated with a bitrate window.

14. A method as recited in claim 9 wherein playback of the joined video frames results in a reverse playback of the video frames.

15. One or more computer readable media having stored thereon a plurality of instructions that, when executed by one or more processors, causes the one or more processors to:
receive a first group of video frames;
receive a second group of video franes, wherein the second group of video frames are to be displayed prior to the first group of video frames;
determine whether playback of the first group of video frames followed by the second group of video frames video frames will cause a buffer violation; and
if a buffer violation would occur, discard at least one video frame in the first group of video frames.

16. One or more computer readable media as recited in claim 15, wherein the first group of video frames are decompressed video frames.

17. One or more computer readable media as recited in claim 15, wherein the second group of video frames are decompressed video frames.

18. One or more computer readable media as recited in claim 15, further comprising adjusting a size associated with a bitrate window.

19. One or more computer readable media as recited in claim 15, further comprising compressing the first group of video frames in reverse order to create a first group of reverse-order compressed video frames.

20. One or more computer readable media as recited in claim 15, further comprising compressing the second group of video frames in reverse order to create a second group of reverse-order compressed video frames.
